(19) United States
(12) Patent Application Publication
(10) Pub. No.: US 2026/0268730 A1
(43) Pub. Date: Sep. 10, 2026

(54) METHODS FOR IMPROVING PARTICIPANT-FACILITATOR RAPPORT IN ONLINE SHARED EXPERIENCE APPLICATIONS

(71) Applicant: Adeia Guides Inc., San Jose, CA (US)

(72) Inventors: Mathew Adams, Matthews, NC (US); Reda Harb, Saint Petersburg, FL (US); Tao Chen, Palo Alto, CA (US)

(21) Appl. No.: 19/074,159

(22) Filed: Mar. 7, 2025

(51) Int. Cl. G07F 17/32

(52) U.S. Cl. CPC G07F 17/323; G07F 17/3293

(57) ABSTRACT

Systems and methods are provided herein for providing a personalized experience for individual users engaged in a virtual group event. More particularly, systems and related methods are disclosed for causing a user device to output a shared experience that is personalized for the user, such as by generating a child persona of a live facilitator of the shared event that is tailored to the preferences of the user. Further, the system tracks events occurring within the shared experience to identify additional opportunities for personalization, such as an opportunity to generate a personalized prompt for the live facilitator based on both the events occurring within the shared experience and stored user data. Additionally, system and methods are disclosed for continuously tracking user interactions in order to build a robust model of user preferences, behavior, and patterns.

### BACKGROUND

This disclosure is related to techniques for improving personalization within shared experience applications.

### SUMMARY

Shared experience applications, such as online casino applications, online education applications, or even social media applications, allow multiple users to enter the same shared experience that is facilitated by a live facilitator. However, being humans, users have both cultural and personal preferences for the appearance of the facilitator and the rapport they have with the facilitator. When the shared experience is not aligning with the preferences of the engaged users, users may lose interest, become discontented, and limit their future engagement with such shared experience applications. Churn rate, which refers to the percentage of people who used a company's services for a period of time but stopped doing so in a given time period, such as a number of players who used to gamble on an online casino platform but have not placed any bets in the last month, is one metric tracked for online services. When a shared experience application has a high churn rate, the shared experience application ultimately wastes resources (e.g., energy and storage) as the application continues to store data related to users who no longer engage with the application. Additionally, a high churn rate results in a high acquisition cost as the shared experience application must continuously bring in new users to replace the old.

Currently, online shared experiences hosted by a live facilitator rely on that live facilitator to keep users engaged and enjoying the shared experience. However, when this live facilitator is interacting with a large number of users, meeting the preferences of each user and keeping each one happy and engaged is challenging. For example, when an older gentleman who is a bit snarky and serious is facilitating an online game of blackjack for ten users, three of the users may appreciate his cynicism and expertise, four of the users may find him outdated and egotistical, two of the users may get their feelings hurt by his unfriendly demeanor, and one user may refuse to participate in a game of blackjack that is not facilitated by a beautiful young woman. While online shared experiences offer an opportunity to build community, have fun, interact with new people, and more, as provided in detail below, improvements are provided, e.g., for the personalization of each user's experience while participating in the online shared experience.

Accordingly, to help address these problems, systems and methods are disclosed herein for learning the preferences of each user and using these learned preferences to enhance a facilitator's perceived appearance and skills to match each user's individual expectations, thereby increasing satisfaction, decreasing churn rate, and optimizing resource usage. For example, the shared experience application may comprise a real-time feedback and cultural/social cue system for facilitators to converse with each player in a personalized manner based on collected user data, such as, for an online casino application, betting history, reactions to betting outcomes, and dealer engagement for each player and their preferences, thereby improving engagement. Further, the shared experience application may generate a user engagement model for each player, map individual player reactions based on analysis of all the player's interactions while engaged with the application and build an emotional and communication model of how/when the player reacts during each gaming session. Further, the shared experience application may generate multiple virtual personas from a single live camera feed of a human facilitator in order to provide personalized facilitator experiences for each player engaged in the same shared experience that additionally modifies the player engagement model so that the interactions match the virtual persona selected.

For example, in some embodiments, the shared experience application receives an indication of entry of an individual entity associated with an individual profile. In some implementations, the shared experience application identifies a facilitator persona based at least in part on inputs received from the individual entity associated with the individual profile. In some embodiments, the shared experience application receives an indication of acceptance of the individual entity by the shared experience application. In some implementations, the shared experience application receives a real-time video and/or audio feed (e.g., from a live facilitator). In some embodiments, the shared experience application tracks an interactive event occurring between the individual entity and a real-time facilitator entity based at least in part on the real-time video and/or audio feed. In some implementations, the shared experience application generates information for output in accordance with the facilitator persona based at least in part on the tracked interactive event.

In some embodiments, the disclosed systems and methods provide a system configured to improve personalization for specific users engaged with an online shared experience, such as a virtual lecture, a virtual auction, or a virtual game of poker. For example, the disclosed systems and methods are configured so that human facilitators of shared experiences receive insights about specific users and users receive a personalized output of the shared experience, thereby ensuring that specific user preferences are accounted for and met, user retention is high, and the shared experience is optimized for each individual user.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts an illustrative system for providing a personalized experience for individual users engaged in a virtual group event, in accordance with some embodiments of this disclosure.

FIG. 2 depicts an illustrative system for providing a personalized experience for individual users engaged in a virtual group event, in accordance with some embodiments of this disclosure.

FIG. 3A is a sequence diagram of providing a personalized experience for individual users engaged in a virtual group event, in accordance with some embodiments of this disclosure.

FIG. 3B is a sequence diagram of providing a personalized experience for individual users engaged in a virtual group event, in accordance with some embodiments of this disclosure.

FIG. 4 depicts an illustrative system for labeling and providing recordings of a virtual group event, in accordance with some embodiments of this disclosure.

FIG. 5 shows illustrative devices and systems for protecting and managing usage of user data for AI model training, in accordance with some embodiments of this disclosure.

FIG. 6 shows illustrative devices and systems for protecting and managing usage of user data for AI model training, in accordance with some embodiments of this disclosure.

FIG. 7 is flowchart of a detailed illustrative process for providing a personalized experience for individual users engaged in a virtual group event, in accordance with some embodiments of this disclosure.

### DETAILED DESCRIPTION

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

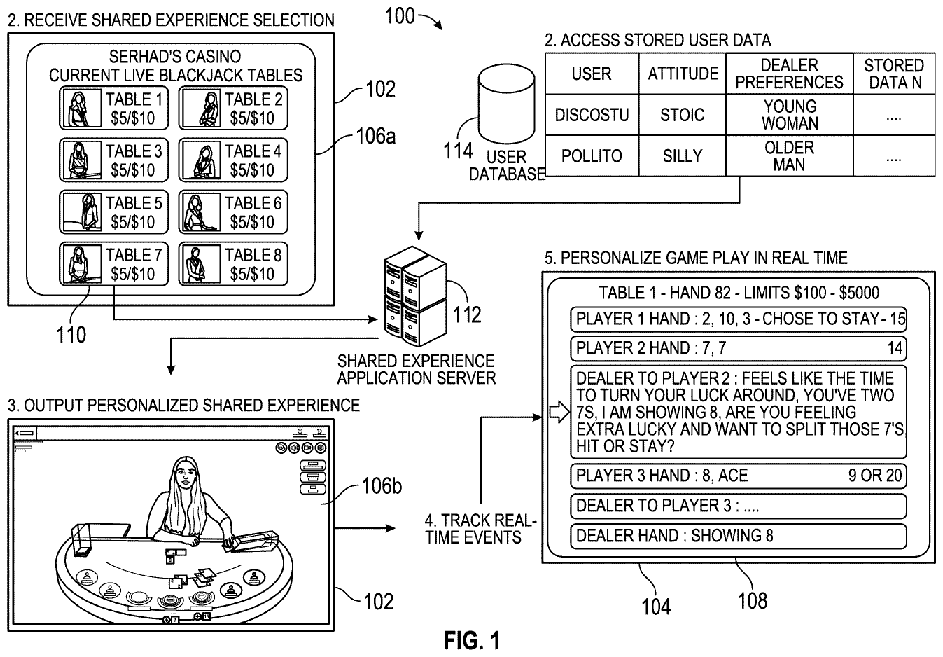

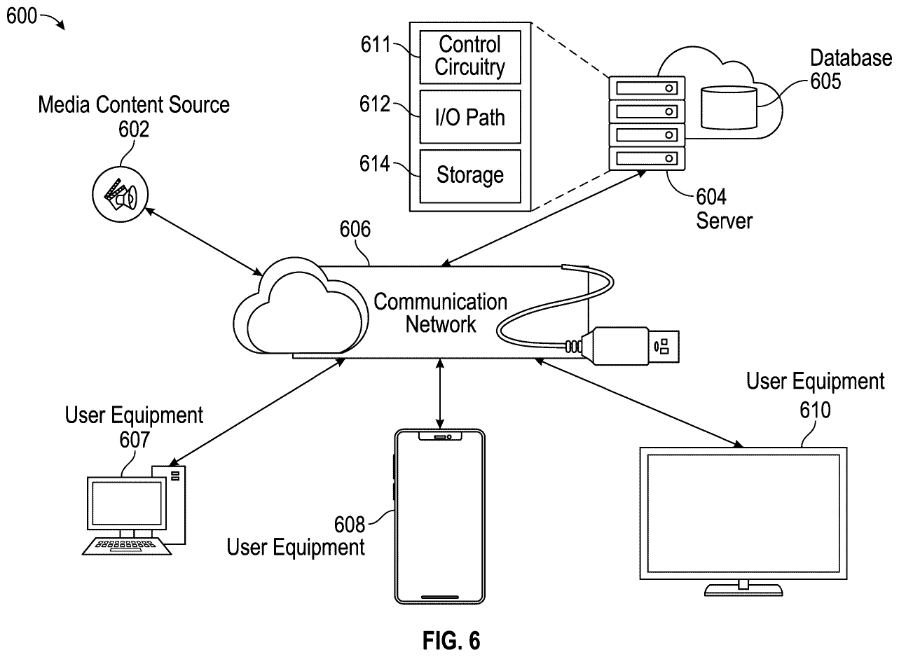

FIG. 1 depicts system 100 (e.g., an engagement system) for providing a personalized experience for individual users engaged in a virtual group event, in accordance with some embodiments of this disclosure. In some embodiments, system 100 (also referred to herein as “the system”) may comprise or correspond to and/or be implemented at/on a user device (e.g., user device 102), one or more servers, any suitable engagement system, or any other suitable device, service, or platform, or any combination thereof. The system may comprise or correspond to an online casino application, an online education application, an online auction application, or any other suitable virtual group event/experience application, which may be executed at least in part on user device 102 of FIG. 1 and/or user equipment 607, 608, or 610 of FIG. 6 and/or at one or more remote servers (e.g., server 604 of FIG. 6) and/or at or distributed across any of one or more other suitable computing devices or network equipment, and in communication over any suitable number and/or types of networks (e.g., the Internet, cellular networks, satellite networks, and/or any other suitable networks). The engagement system (e.g., system 100) may be configured to perform the functionalities (or any suitable portion of the functionalities) described herein. In some embodiments, the engagement system and/or the virtual group event/experience application may be a stand-alone application or may be incorporated as part of any suitable application or system. The engagement system may comprise or employ any suitable number of displays, sensors or devices such as those described in FIGS. 1-7, or any other suitable software and/or hardware components, or any combination thereof.

In some embodiments, the engagement system (e.g., system 100) may be installed at or otherwise provided to (and accessed by) a particular computing device, may be provided via an application programming interface (API), or may be provided as an add-on application to another platform or application. In some embodiments, software tools (e.g., one or more software development kits (SDKs)) may be provided to any suitable party for implementation of the functionalities described herein.

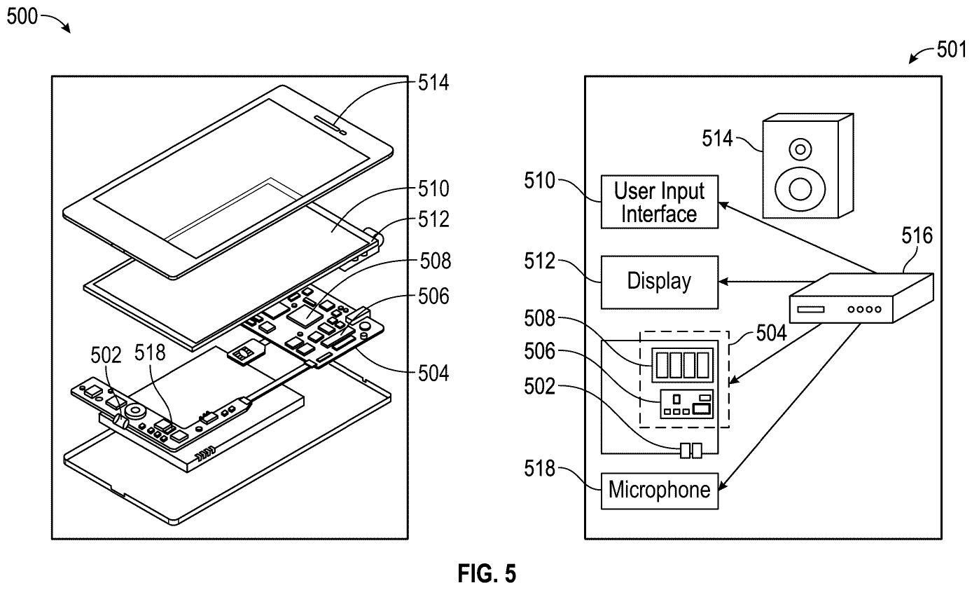

In some implementations, system 100 comprises user device 102 or facilitator device 104 of FIG. 1, or any number of devices (e.g., server 604 of FIG. 6), comprising software and hardware components, such as, for example, control circuitry and memory, and may correspond to one or more of devices 607, 608, and/or 610 of FIG. 6. In some embodiments, the control circuitry of user device 102 and/or facilitator device 104 is control circuitry 504, as further described in FIG. 5 below. The hardware components and applications installed on user device 102 and/or facilitator device 104 may be managed by an operating system (OS) (e.g., iOS, Android, webOS). System 100 may implement the techniques depicted in FIG. 1 based on instructions stored in non-transitory memory (e.g., non-transitory memory 508 of FIG. 5, or storage 614 of FIG. 6). System 100 may configure user device 102 and/or facilitator device 104 (or the devices may be preconfigured) to download, install or otherwise access applications (e.g., an online casino application, an online education application, an online auction application, or any other suitable applications, or any suitable combination thereof) and allow a user of user device 102 and/or a facilitator of facilitator device 104 to access and manage these applications, e.g., via user interface 106a, user interface 106b, and/or facilitator interface 108) of user device 102. In some embodiments, user device 102 and/or facilitator device 104 downloads applications over communication network 606 of FIG. 6.

In some embodiments, user device 102 and/or facilitator device 104 may be a mobile device such as, for example, a smartphone or tablet. In some embodiments, user device 102 and/or facilitator device 104 may comprise or correspond to a laptop computer, a personal computer, a desktop computer, a smart television, a smart watch or wearable device, smart glasses, a stereoscopic display, a wearable camera, extended reality (XR) glasses, XR goggles, a near-eye display device, or any other suitable user equipment or computing device, or any combination thereof.

In some embodiments, the disclosed system (e.g., system 100) comprises one or more applications on a user device (e.g., smartphone) configured to collect real-time data adhering to predefined categories, utilizing structured data templates based on the type of data being collected. In some implementations, the system (e.g., system 100) receives data from applications on the user device that can be processed either locally on the user device or in the cloud, allowing system 100 to integrate data collected from third-party sources. In some embodiments, the system ensures user control of storage, usage, and collection of data and associated preferences, maintaining data collection and usage transparency and agency. In some implementations, a centralized settings panel within the settings menu of the user device provides seamless management of user consent. In some embodiments, the system provides real-time data collection notifications and detailed logs to enhance user transparency and control over their data. In some implementations, the system includes an optimization component that may be based at least in part on historical usage patterns and real-time activity recognition to determine optimal bandwidth and network usage, thereby reducing disruption to the user. In some embodiments, the system utilizes differential privacy techniques to anonymize user data before the data is used by the system, thereby ensuring that individual data points cannot be traced back to specific events and/or users. In some implementations, the system incorporates a hybrid training approach and/or inferencing approach, combining local and cloud computing to balance computational loads and enhance performance.

As shown in FIG. 1, in some embodiments, system 100 comprises user device 102, facilitator device 104, user interface 106a having selectable option 110, user interface 106b, facilitator interface 108, shared experience application server 112, user database 114. In some implementations, the system stores user database (or datastore) 114 in non-transitory memory, user database 114 comprising any suitable amount of stored data (e.g., specific attitudes, dealer preferences, typical engagement patterns, preferred engagement times, or any other suitable data) for any suitable number of users (e.g., every user registered in the shared experience application). Shared experience application server 112 may be, for example, a server for an online casino application, an online education application, an online auction application, or any suitable application. In some embodiments, system 100 provides a shared experience hosted by a real person being filmed and outputs an audio and/or video of the real person to user device 102, optionally modifying the audio and/or video of the real person based on data corresponding to the user of user device 102. In some implementations, system 100 provides a shared experience facilitated by a facilitator bot, which is managed by an engagement model in order to personalize the functionality of the facilitator bot for each respective user engaged in the shared experience.

In some embodiments, system 100 generates for display, on user device 102, user interface 106a comprising a plurality of selectable options corresponding to a plurality of blackjack tables available to be gambled on via an online casino application (e.g., as provided by shared experience application server 112). In some implementations, system 100 receives an input corresponding to a selection of selectable option 110 (e.g., corresponding to Table 7). In some embodiments, system 100 transmits an indication of the selection of selectable option 110 to shared experience application server 112. In some implementations, system 100 identifies a user profile associated with the selection of selectable option 110 (e.g., the user profile associated with user device 102) and transmits an indication of the identified user profile to shared experience application server 112. For example, in some embodiments, system 100 determines that user device 102 is signed in to the user account “discostu” on the online casino application, receives a selection of selectable option 110 (e.g., Table 7) via user interface 106a of user device 102, and transmits an indication of the selection of selectable option 110 by discostu to shared experience application server 112 (e.g., an online casino application server).

In some implementations, system 100 receives any suitable input via user interface 106a and transmits an indication of the received input to shared experience application server 112. For example, in some embodiments, system 100 receives a selection of a specific shared experience to join (e.g., having a specific facilitator, having a specific value assigned to the experience such as a betting amount for a card game on an online casino application, having a unique session ID, having a specific associated game, or any other suitable unique attribute or any suitable combination thereof) or a selection of an option to launch a shared experience (e.g., a generic “Begin” selection to launch a suitable shared experience as determined by system 100). In some implementations, system 100 determines a unique session ID for each shared experience offered by the shared experience application. Additionally, in some embodiments, the system determines a session ID for every user engaged in a shared experience, with some users being associated with multiple shared experiences and therefore having multiple session IDs (e.g., associated with their respective user profile). In some embodiments, the system provides a session ID associated with a first user to a second user (e.g., so the second user can join the shared experience the first user in engaged with because the first and second user are friends). In some implementations, system 100 receives a plurality of selections via user interface 106a in order to determine a shared experience to be launched at user device 102. For example, in some embodiments, system 100 receives a selection of a game, a selection of a bet to be applied to the game, a selection of a facilitator to run the game, and any other suitable selection or combination thereof. Further, for example, in some implementations, system 100 receives a selection to join a shared experience that is designated as the most popular, as having the best odds, as recommended for the specific user accessing the shared experience application, as having been most recently accessed by the user, or any other suitable designation or combination thereof.

In some implementations, system 100 accesses user data stored in user database 114. In some embodiments, system 100 accesses stored user data corresponding to a user associated with the selection of selectable option 110. For example, in some implementations, system 100 accesses user data of discostu comprising a stored attitude of discostu (e.g., stoic), a stored dealer preference of discostu (e.g., young woman), or any other stored data of discostu. For example, in some embodiments, system 100 stores any number of suitable preferences or data associated with discostu such as a preferred language, a preferred accent, a preferred betting amount, a preferred theme, a preferred game, a record of past games played, a record of past reactions by discostu, a preferred facilitator, a preferred number of fellow participants engaged in the shared experience, and/or data received from third-party sources (e.g., other shared experience applications, other applications, social media accounts, gaming applications, or any other suitable third-party source or combination thereof), determined shared experience application usage patterns (e.g., time of day of use, length of use, mode of use, functions utilized, or any other suitable usage pattern or combination thereof). In some embodiments, system 100 populates user database 114 with data based on initial user selections (e.g., system 100 provides a plurality of prompts via user interface 106a to determine specific user preferences and receives a plurality of inputs and/or selections indicating these preferences) as well as based on user interactions with the shared experience application over time (e.g., by tracking user behavior on the shared experience application such as games played or engagement times).

In some embodiments, system 100 collects data by tracking user interactions (e.g., voice data, web activity, application activity, location data, communications with other users, and/or any other suitable data) with the user interface (e.g., user interface 106a, user interface 106b) of user device 102 or data otherwise received by user device 102 or associated with a user of user device 102. For example, in some implementations, system 100 tracks user interactions with the user interface of user device 102 when the user interface is displaying any of applications native to user device 102, applications that have been downloaded to user device 102, applications being accessed via user device 102, websites being accessed via user device 102, or any other suitable interactive display. In some examples, system 100 includes a data collection module with various sensors on the user device (e.g., mobile device, XR goggles), including accelerometers, gyroscopes, cameras, microphones, touchscreens, and/or any other suitable components that are utilized to capture user interactions such as typing patterns, application usage, voice assistant usage, interactions with other people through social media network APIs and SMS text APIs, and navigation habits. Further, in some embodiments, system 100 stores data in user database 114 according to a specific application the data was collected and/or received from (e.g., an online casino application, an online education application), a specific topic (e.g., favorite movies, preferred language and/or accent), a data type (e.g., categorical data, numerical data, text data), or any other suitable organization structure in user database 114. In some embodiments, system 100 provides the data from user database 114 to a user engagement model so that the engagement model may continuously fine-tune internal logic of the model to refine an ability of the model to provide personalized shared experiences to a user of user device 102. In some embodiments, the engagement model may be trained via supervised learning or unsupervised learning and/or using reinforcement learning techniques.

In some implementations, system 100 stores data in user database 114 with additional metadata or hidden data, such as, for example, the application the data was mined from, the location of user device 102 when the data was collected, the date and time of when the data was collected, or any other suitable metadata that further describes the stored data. In some implementations, system 100 generates for display an indication that interactions with the user interface are being tracked and/or determines whether or not interactions with the user interface may be tracked based on settings previously defined by the user and accessible to system 100.

In some embodiments, system 100 receives, collects, and/or stores data from multiple applications that provide similar services or data in user database 114. For example, in some embodiments, system 100 stores data from multiple online casino applications installed on user device 102. In some implementations, system 100 uses data fusion techniques and correlation analysis to generate generalized data to be stored in user database 114. For example, in some implementations, system 100 collects and/or receives data from multiple online casino applications and generates and stores aggregated data points based on the collected and/or received data. In some embodiments, system 100 utilizes federated learning techniques to maintain user privacy and prevent the sharing of raw data between applications. In some implementations, system 100 receives aggregated insights from an application when the application processes data locally. In some embodiments, system 100 combines the aggregated insights provided by applications to improve (e.g., fine-tune, train, retrain, modify) a user engagement model, thereby improving accuracy of user preferences (e.g., based at least in part on diverse data sources) while preserving user privacy. In some embodiments, system 100 consistently updates and modifies the data stored in user database 114 to reflect the current state of the user. For example, in some embodiments, system 100 accesses user data indicating that the user likes puns, prompts the facilitator of the shared experience to say puns, determines based on facial tracking and audio monitoring that the user is not smiling or laughing in response to the puns, and updates user database 114 to indicate that the user does not particularly enjoy puns.

In some embodiments, system 100 provides a user interface, accessible via user device 102 such as, for example, within the settings menu of the shared experience application, comprising a listing or summary of the data stored within user database 114. In some implementations, system 100 provides the modification of the data stored within user database 114 at the user interface comprising the listing or summary of the stored data. For example, in some embodiments, system 100 provides a navigable user interface at user device 102 that may be interacted with to view a representation of all data that is stored within user database 114. In some implementations, system 100 organizes the presented data (e.g., the data stored within user database 114 via the navigable user interface) according to any of the source of the data (e.g., the application, platform, service, or other suitable source that the data was mined from), the topic of the data, the type of data, or any other suitable organization system to provide efficient browsing and review of the stored data. In some embodiments, system 100 allows data stored within user database 114 to be manually deleted and/or modified, and/or new data to be manually added (e.g., by a user of user device 102). For example, in some implementations, when the navigable user interface comprising the listing or summary of the data stored within user database 114 indicates that a user preference for a blackjack dealer is stored as “handsome young man” and the user of user device 102 sees the user preference for the blackjack dealer but knows that they prefer their dealers to be elderly, system 100 subsequently receives a user input and/or a series of user inputs via the navigable user interface to replace the user preference for “handsome young man” with a user preference for “homely older woman” (e.g., a selection of an option to delete the “handsome young man” dealer preference, a selection of an option to add a new dealer preference, a plurality of selections of letters of a keyboard to spell the words “homely older woman,” and a selection of an option to input the typed dealer preference). Further, in some embodiments, system 100 deletes the data corresponding to the user preference for “handsome young man” from user database 114 and adds data corresponding to a user preference for “homely older woman” to user database 114. In some implementations, system 100 automatically deletes and/or modifies data stored in user database 112 (e.g., in response to a receiving input that contradicts stored data), and/or adds new data to user database 112 (e.g., in response to receiving input that indicates a new preference, pattern, or behavior of a user).

In an embodiment, system 100 applies differential privacy techniques to anonymize user data before the data is transmitted/uploaded to user database 114 to be used for personalization by system 100 (e.g., by a user engagement model). In some implementations, system 100 utilizes privacy-preserving technologies such as, for example, Apple's Differential Privacy and Google's TensorFlow Privacy library, or custom implementations thereof, or any other suitable privacy-preserving technology, to ensure that individual data points cannot be traced back to specific actions. In some embodiments, system 100 adds controlled random noise to the data stored or to be stored in user database 114, thereby making difficult identification of any single data point while still allowing for useful analysis. In some implementations, system 100 changes the amount and type of noise added to each data point based on the sensitivity of the data point and the desired level of privacy.

In some embodiments, system 100 outputs a personalized shared experience via user interface 106b at user device 102, which may be based at least in part on the data accessed via user database 114. In some implementations, when the shared experience is hosted by a facilitator, system 100 modifies the representation of the facilitator (e.g., visually or audially) as depicted via user interface 106b and/or output via user device 102. For example, in some embodiments, system 100 modifies a look of the facilitator (e.g., hair, eyes, outfit, or any other suitable attribute or combination thereof) and/or a sound of the facilitator (e.g., language spoken, accent, volume, or any other suitable aspect or combination thereof). In some implementations, system 100 modifies a setting of the shared experience, such as by depicting the shared experience as happening on a beach, in a forest, at a ski resort, by a fireplace, or any other suitable setting. In some embodiments, system 100 generates for output, by user device 102, a shared experience selected by a user of user device 102 that has been tailored to the preferences of the user (e.g., based on the data stored in user database 114 and/or based on input received from the user).

For example, in some embodiments, when the shared experience comprises a video (e.g., livestreamed or on-demand) of a lecture by a world-renowned professor who speaks German and has really long, flowy hair that viewers may find distracting, system 100 (a) translates the German to English to output audio in English and closed captioning in English based on stored data indicating that the user of user device 102 only speaks English or based on preferred language that is set on the user device 102 and (b) modifies the visual depiction of the professor, as output via user interface 106b, so that the professor is shown to have a short and stiff bob based on input received from the user indicating that the long, flowy hair was distracting. In some implementations, system 100 receives inputs from the user indicating modifications to be made to the output of the shared experience. In some embodiments, system 100 provides selectable options, via user interface 106a and/or user interface 106b, corresponding to possible modifications (e.g., change the hair of the facilitator, change the background of the shared experience, change the language of the audio, or any other suitable modification or combination thereof). In some implementations, system 100 is configured to receive textual commands via user interface 106a and/or user interface 106b, interpret the textual commands, and modify the shared experience based on the received textual commands (e.g., which may be based at least in part on a language model, a diffusion model, or any other suitable model or combination thereof).

In some embodiments, system 100 tracks real-time events occurring in the shared experience, such as events in a game (e.g., a card is played, a die is rolled, someone busts in blackjack), conversations (e.g., textual, audial, and/or visual) between the user of user device 102 and the facilitator of the shared experience, conversations between the user and other participants in the shared experience, reactions of the user (e.g., a facial expression, a verbal utterance, selection of an emoji reaction via user interface 106b, a biometric change as recorded by a sensor of user device 102), inputs received via user interface 106b, or any other suitable event or combination thereof. For example, when user device 102 comprises an extended reality headset environment including touch controllers, system 100 tracks (e.g., by the touch controllers) the eye movements, verbal utterances, heartrate, sweat levels, and any other suitable biometric data of the user to determine an emotional state of the user. In some implementations, system 100 tracks biometric data of the user via touch controllers, a smart watch, a smart ring, any suitable device having sensors and/or hardware configured to measure and/or record biometric data, or any combination thereof. For example, in some implementations, system 100, when tracking real-time events occurring in the shared experience comprising a high stakes blackjack game, detects that the user of user device 102 requested a “hit,” that a card was played that resulted in a bust, that the user's heart rate increased to 105 bpm from 92 bpm, that the temperature of the user's skin increased, and that the user muttered a series of expletives. Further, for example, in some embodiments, system 100 determines that the user of user device 102 is in an agitated state.

In some embodiments, system 100 personalizes game play in real time, e.g., based on the tracked real-time events. For example, when system 100 determines that the user of user device 102 is in an agitated state, system 100 initiates a personalized “calm-down” protocol comprising changing the background music from songs by Pitbull to beach waves; changing the depiction of the facilitator (e.g., the blackjack dealer) to be that of a sweet old lady; indicating to the facilitator via facilitator interface 108 that the user is in an agitated state; providing a prompt via facilitator interface 108 suggesting the facilitator to calmly say “Let's all take a minute to pause, breathe . . . and smile” or any other suitable phrase indicated as being calming to the user; providing a pop-up alert at user device 102 e.g., suggesting the user practice some form of self-care (e.g., “Maybe it's time to take break”), reminding the user that a given scenario is likely to be OK (e.g., “Hey! You have still won more money than you have lost!”), providing a resource (e.g., a website or phone number the user may want to access to help their mood), providing an image that is indicated as having calming effects on the user (e.g., a kitten in a teacup), or any other suitable pop-up alert or combination thereof; modifying the output audio to have a soothing Southern accent; or any other suitable modification or combination thereof.

In some embodiments, system 100 personalizes real-time gameplay by providing personalized prompts to the dealer based on the tracked events that occurred. For example, in some implementations, when system 100 determines that the user has been on a losing streak (e.g., based on tracking the results of the gameplay) but likes to take risks (e.g., based on a gameplay history stored in user database 114), system 100 prompts the dealer of the game, via facilitator interface 108, to say “Feels like it's time to turn your luck around. You have two 7's, I am showing 8. Are you feeling extra lucky and want to split those 7's? Or would you rather hit or stay?” In some embodiments, system 100 generates a prompt to provide to the facilitator based on data stored in user database 114 and the tracked real-time events, such as generating a prompt containing a good dad joke when the tracked real-time events indicate that the user is in a good mood (e.g., tracked gameplay indicates a winning streak and facial detection indicates a smile) and the stored data indicates that the user loves a good dad joke (e.g., a social media application shared data with the shared experience application indicating that the user has only ever “liked” posts containing jokes classified as “dad jokes”). In some implementations, system 100 mines content created by the user (e.g., written posts, videos) to identify, e.g., topics, phrases, or any other suitable preferences or interests of the user in order to provide personalized prompts to the facilitator to improve user engagement.

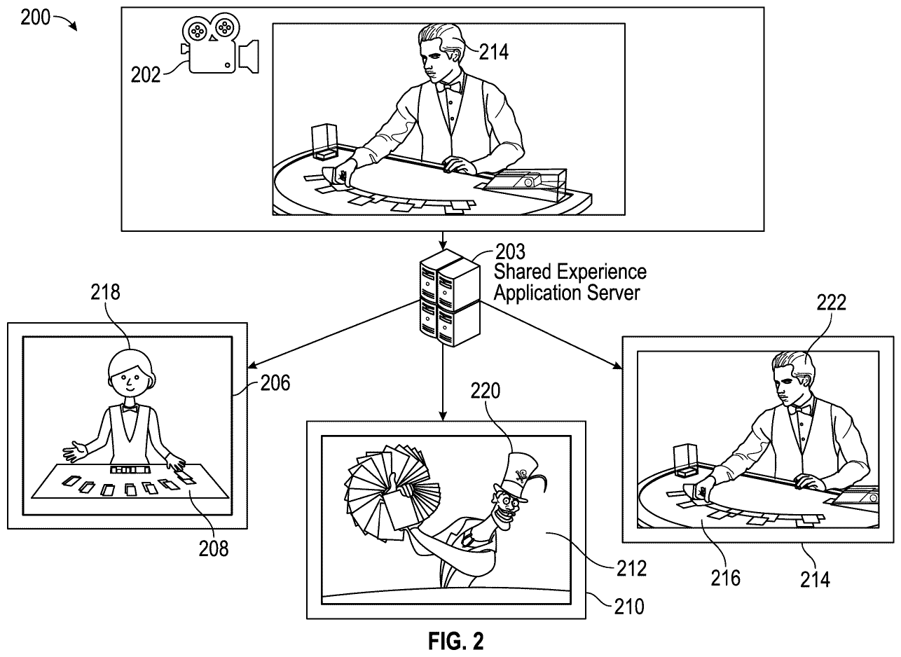

FIG. 2 depicts system 200 for providing a personalized experience for individual users engaged in a virtual group event, in accordance with some embodiments of this disclosure. As shown in FIG. 2, in some embodiments, system 200 receives a livestream of an event (e.g., a card game, an auction, a lecture), as hosted by facilitator 204 (e.g., a dealer, an auctioneer, a teacher) and recorded by recording setup 202 (e.g., a smartphone, a laptop, an extended reality device, a tablet), transmits the video of the event to shared experience application server 203, and transmits a depiction of the event to user device 206, user device 210, and user device 214, the depiction being personalized for each respective user and generated for display at user interface 208, user interface 212, and user interface 216, respectively. In some embodiments, system 200 is system 100 of FIG. 1, shared experience application server 203 is shared experience application server 112 of FIG. 1, recording setup 202 is facilitator device 104 of FIG. 1, and user device 206, user device 210, and/or user device 214 is user device 102 of FIG. 1. In some implementations, system 200 receives the livestream of an event from recording setup 202 comprising a camera and a suitable connection to shared experience application server 203 (e.g., an Internet connection).

In some embodiments, system 200 transmits a video of the livestream of the event to shared experience application server 203 which identifies a plurality of users indicated as engaged with the event (e.g., the shared experience) and generates and transmits a personalized depiction of the event for each user device. In some implementations, system 200 (e.g., by shared experience application server 203) accesses data associated with each respective user (e.g., from user database 114 of FIG. 1) in order to personalize each respective depiction of the livestream. In some implementations, system 200 receives inputs from each respective user in order to personalize each respective depiction of the livestream (e.g., each user selects a preferred depiction of facilitator 204). In some embodiments, system 200 (e.g., by shared experience application server 203) transmits a generated personalized depiction of the recorded event to each respective user device (e.g., user device 206, user device 210, and user device 214). In some implementations, system 200 (e.g., by shared experience application server 203) causes the generated personalized depictions to be interactive (e.g., the depiction is configured to allow for users to speak, send chats, send reactions, select options corresponding to an activity associated with the event, or perform any other suitable interaction). In some embodiments, system 200 classifies facilitator 204 as a parent persona and classifies facilitator 218, facilitator 220, and facilitator 222 as child personas, with the depictions of the child personas being based on the parent persona (e.g., when facilitator 204 flips a card, system 200 causes each respective user interface to depict the respective child persona flipping the same card as facilitator 204).

In some embodiments, system 200 (e.g., by shared experience application server 203) accesses user data associated with the user of user device 206 in order to generate the personalized depiction of the event via user interface 208 of user device 206. In some implementations, system 200 determines that the user of user device 206 prefers an animated woman facilitator and subsequently generates for display facilitator 218 at user device 206 (e.g., in place of facilitator 204). In some embodiments, system 200 additionally modifies an audio of facilitator 204, as received and transmitted by recording setup 202, based on the accessed user data. For example, in some implementations, system 200 determines that facilitator 204 speaks with a British accent (e.g., by an audio processing module), accesses user data indicating that the user of user device 206 cannot stand a British accent but loves a country twang, transmutes the received audio to generate a modified audio comprising the same words spoken by facilitator 204 but spoken with a country twang in place of the British accent (e.g., by voice generator), and transmits the modified audio for output at user device 206. In some embodiments, system 200 continues to personalize the depiction of the event throughout the duration of the event (e.g., as disclosed in the discussion of FIG. 1).

In some embodiments, system 200 (e.g., by shared experience application server 203) accesses user data associated with the user of user device 210 in order to generate the personalized depiction of the live event via user interface 212 of user device 210. In some implementations, system 200 accesses user data indicating that “The Princess and the Frog,” the 2009 American animated musical romantic fantasy comedy film produced by Walt Disney Animation Studios and released by Walt Disney Pictures, is a favorite movie of the user (e.g., data received from a streaming platform such as Disney+indicates that the user streams “The Princess and the Frog” every Friday night) and subsequently generates for display facilitator 220 (e.g., Dr. Facilier, the villain of the movie who uses cards) at user device 210 (e.g., in place of facilitator 204). In some embodiments, system 200 transcribes the audio of facilitator 204, as received and transmitted by recording setup 202, and generates a personalized audio (e.g., by a voice modulator) for output at user device 210, the personalized audio generated to sound like Dr. Facilier. In some implementations, system 200 provides a respective plurality of facilitator options to each respective user (e.g., by the respective user interface of each user device), each respective plurality of facilitator options based on respective user data (e.g., the plurality of facilitator options corresponding to characters indicated as being favorites of the user or the plurality of facilitator options having traits indicated as favorable to the user). In some implementations, system 200 provides any number of potential facilitator depictions (e.g., characters from popular media, designed characters, generic characters). In some embodiments, system 200 continues to personalize the depiction of the event throughout the duration of the event (e.g., as disclosed in the discussion of FIG. 1). For example, in some embodiments, system 200 determines that the user is growing afraid of Dr. Facilier (e.g., facilitator 220) based on collected facial data indicating fear and collected heartrate data indicating spikes in heartrate corresponding to every time Dr. Facilier speaks, provides the user a selectable option to change the depiction of facilitator 220 (e.g., a pop up that says “Do you want to try engaging with a new facilitator?” and a selectable option corresponding to “Yes” and/or a plurality of selectable options corresponding to a plurality of child personas of facilitator 204), and causes facilitator 220 to be replaced by a new child persona (e.g., based on receiving a user selection of a new facilitator from a plurality of provided options and/or based on user data).

In some embodiments, system 200 (e.g., by shared experience application server 203) accesses user data associated with the user of user device 206 in order to generate the depiction of the live event via user interface 216 of user device 214. In some implementations, system 200 determines that the user of user device 206 prefers an unmodified depiction of the event and subsequently generates for display user interface 216, depicting the unmodified live event (e.g., the exact video recorded by recording setup 202). In some embodiments, system 200 generates for display facilitator 222 at user interface 216, facilitator 222 directly corresponding to facilitator 204. In some implementations, system 200 modifies an audio of facilitator 204, as received and transmitted by recording setup 202, based on the accessed user data. For example, in some implementations, system 200 determines that facilitator 204 speaks English (e.g., by an audio processing module), accesses user data indicating that the user of user device 206 only speaks French, generates a French audio (e.g., by a voice generator), and transmits the modified audio for output at user device 206. In some embodiments, system 200 continues to personalize the depiction of the event throughout the duration of the event (e.g., as disclosed in the discussion of FIG. 1).

In some embodiments, system 200 (e.g., by shared experience application server 203) generates each respective personalized depiction of the event based on user preferences (e.g., as determined based on collected and/or received data or based on input received from the respective user device of each user, directly indicating preferences). In some implementations, system 200 accesses user-defined personalization settings comprising indications of what aspects of the event (e.g., shared experience) the user wants and/or allows to be modified. For example, in some embodiments, system 200 accesses the user-defined personalization settings corresponding to the user of user device 214 and determines that (a) the user does not allow for any modification to the livestream recorded by recording setup 202, (b) the user wants system 200 to personalize the audio of the event (e.g., by modifying the words spoken by facilitator 204 to have an Irish accent and by adding background music), and (c) that the user allows for system 200 to provide prompts (e.g., provide suggested phrases or comments to facilitator 204 based on stored user data and/or the tracked event) and/or information about the user (e.g., that the user is in a bad mood) to facilitator 204 (e.g., by providing an alert or pop-up at facilitator device 104 of FIG. 1).

In some embodiments, a user engagement system (e.g., player engagement system) provides real-time prompts for a live facilitator (e.g., a live dealer) of the shared experience in order to provide the live facilitator with prompts for engaging individually with each participant of the shared experience (e.g., each player at the table), as well as the entire group of participants (e.g., the entire table) in a manner that fits the requirements of each individual participant as identified in their user profile (e.g., player profile). In some implementations, the user engagement system provides the facilitator of the shared experience with relevant information for building a close relationship with participants and therefor better understanding the requirements and expectations or participants, which research shows leads to a high level of commitment from the participants. In some implementations, the user engagement system focuses on, e.g., the four areas of likeability, expertise, customer orientation, and physical attractiveness and provides prompts, advice, tips, modifications, and any other suitable aspect or combination thereof based on these four areas in order to increase participant satisfaction and commitment. In some embodiments, commitment, a factor affecting future behavioral intentions of participants/users, is defined, for example, as “an exchange partner believing that an ongoing relationship with another is so important as to warrant maximum efforts at maintaining it” (e.g., the committed party believes the relationship is worth working on to ensure that the relationship endures indefinitely). In some embodiments, the user engagement system tracks, estimates, or determines commitment of a user in order to understand the strength of the relationship between each user and the shared experience application, as committed users are more likely to have a strong desire to develop a long-lasting relationship with the shared experience application. In some implementations, the user engagement system is designed to assist the facilitator (e.g., dealer) in improving their likeability, expertise, and customer orientation, while a virtual persona system modifies the generated display of the shared experience to maximize perceived physical attractiveness and/or generates the display in accordance with the preferred aesthetics of each user.

In some embodiments, the shared experience application (e.g., the online casino application) generates a user profile by tracking and/or storing (e.g., in user database 114 of FIG. 1) every interaction between the user and the shared experience application (e.g., every tap, selection, message sent, word spoken, biometric reaction) and connecting the user profile to other accounts the user has on other apps/site in order to build a more in-depth model of each user to better understand how to keep them engaged. In some implementations, the shared experience application utilizes data generated by the shared experience application by combining the data with analysis of all the interactions of the user with the shared experience application to build an emotional and communication model of how/when the player reacts during each usage session (e.g., how/when the player reacts during a poker game). For example, in some embodiments, when the shared experience application is an online casino application, the online casino application configures the emotional and communication model to learn how the player reacts when the player wins, if the player interacts more with the dealer or with other players, if the player prefers silence when losing, if the player stays more engaged when receiving positive feedback, or any other suitable insight into the players gaming preferences and/or patterns or any combination thereof. In some implementations, the shared experience application uses the audio and/or video feeds (e.g., from any of a user device or a facilitator device such as user device 102 or facilitator device 104 of FIG. 1) of the live shared experience to extract data, e.g., for building a model of the emotional responses of a user and/or multiple users. For example, in some embodiments, when the camera of a user device engaged with the shared experience application is directed at the face of the associated user, and/or the XR headset being used by a user to engage with the shared experience application is capable of delivering video of the face of the user to the shared experience application (e.g., the shared experience application server 112 of FIG. 1), the shared experience application collects a huge volume of data (e.g., that the system can extract additional biometric data from), provided the shared experience application has received an indication of consent from the player. For example, in some implementations, when the shared experience application has received an indication that a player consents to biometric tracking (e.g., or specific biometric parameter tracking) throughout engagement with the shared experience application and/or a particular shared experience, the system (e.g., system 100 of FIG. 1) tracks facial expressions, eye movement, heartrate, or any other suitable biometric parameter throughout the duration of the user's engagement and in accordance with the indicated consent, to provide the best sense of the current emotional state of the user. In some embodiments, the system determines a more accurate and/or refined assessment of the state of mind of a user when the system has access to additional data (e.g., the system collects biometric data in addition to tracking events occurring within the shared experience), thus allowing the engagement system to detect less obvious reactions during engagement (e.g., gameplay).

In some embodiments, the system tracks the body and hands of a user via a camera or XR headset associated with the user engaged with the shared experience application to provide tracking data to animate a virtual persona of the user. In some implementations, after a user has engaged with several shared experiences (e.g., has played multiple games of blackjack), the system analyzes the tracked movement data to map out meanings associated with specific movements. For example, in some implementations, when the shared experience application corresponds to an online casino application, the system, in order to provide a more realistic simulation of playing blackjack (e.g., or any other suitable game) at a physical table (e.g., or in a physical casino), determines (e.g., based on tracked movement and gameplay data of a user and/or based on input received by a user defining a meaning behind an action) that a flat wave of a hand or tapping on the table by a user corresponds to the user wanting to stay or take another card, respectively, in a blackjack game (e.g., an insight); provides this insight to the dealer (e.g., by presenting at facilitator device 104 of FIG. 1 a legend outlining various user movements and their corresponding meanings); continuously tracks/monitors user movements to identify when a meaningful movement has occurred (e.g., by analyzing the camera feed received from the device of a user to identify when a movement has been made that is indicated as having meaning within the gameplay environment, such as tapping on the table); and ensures that this movement is accounted for within the shared experience (e.g., when the system determines that the user has tapped the table to request another card, the system alerts the live dealer to the movement and prompts the dealer to deal the user a card and/or automatically causes another card to be dealt to the user).

In some embodiments, the system feeds the user engagement system by a tracking system that is configured to analyze the video feed received from a user device and/or a facilitator device and validate events corresponding to the shared experience (e.g., each move occurring during gameplay and the results of each game, or the progression of a live auction and the ultimately selling price to a specific user). In some implementations, the system is used to provide preferred timing for facilitator/user interactions. For example, in some embodiments, when a blackjack dealer deals out a first card to each player and then themselves before dealing a second card to each player and then a second card to themselves face down, thus beginning an interaction cycle where the dealer interacts with each player in turn to let the player hold, hit, double down, or split, the system, by a game tracking system, provides specific information to the dealer to allow the dealer to perform these interactions as well as possible (e.g., maximizing the likeability, expertise, or customer orientation). For example, in some implementations, the system feeds the player engagement system for personalization an initial prompt based on the initial dealing by the dealer. In some embodiments, the system identifies what cards are dealt to each player (e.g., by a game tracking system based at least in part on an image recognition module), determines what options are available to each player (e.g., based on gameplay logic), determines a current state of the game for each player (e.g., a player dealt an ace is in a good current state), generates a basic prompt for each player (e.g., “Player 1 do you want to split, hold or hit?”), personalizes (e.g., by the player engagement system) the generated prompt for each respective the player, and delivers the personalized prompt to the dealer in real time so that the dealer will say the personalized phrase to the player. In some implementations, the game tracking system continuously generates and provides additional prompts to help with engagement during gameplay. In some embodiments, when the game (e.g., a shared experience) ends, the system determines and provides additional opportunities and/or methods to the dealer to provide personalized interactions with each player (e.g., participant), such as the system providing an interaction prompt based on the just completed game's outcome (e.g., providing a prompt to the dealer stating “You played a great game . . . but you can't win them all” with an indication to say the statement to a player who lost the game and is indicated as enjoying classic sayings).

In some embodiments, the player engagement system generates prompts in response to being triggered by the game tracking system, so that the dealer is initiating interactions in a timely manner and providing game-specific information in an efficient manner to each player, which we can consider the dealer's minimum capability. In some implementations, with the focus of the player engagement system being to bring a consistent level of likeability, expertise, and customer orientation to the pool of dealers so that in addition to the minimum capability of delivering the game and play-specific information to each player when each player is required to take action, the player engagement system generates prompts that provide a more personalized comment. For example, in some embodiments, when a player is dealt a pair of 10s in a game of blackjack, which will allow the player to hold, draw or split the 10s to make 2 hands (e.g., the expected play for an experienced player), the player engagement system identifies a simple interaction to provide to the dealer (e.g., “Player 1, do you want to split, hold or hit?”), accesses user data (e.g., as stored in user database 114 of FIG. 1) indicating that the player typically does not split their 10s (e.g., information that the dealer would not have), and generates and provides a personalized and more specific prompt to the dealer (e.g., “Player 1, you typically do not like to split your 10s, but are you feeling bold today? Or are you holding?”). In some implementations, system 100 identifies small changes that can be made throughout gameplay to allow the dealer to demonstrate both expertise (e.g., by demonstrating their understanding of the player's unusual betting behavior) and their likeability (e.g., by being playful, which the player engagement system has also identified as something Player 1 enjoys). In some embodiments, system 100 identifies and suggests to the dealer small additions based on user data in order to improve dealer/player interactions and provide a stronger rapport to be built between the dealer and the player.

In some embodiments, the player engagement system comprises a text style transfer (TST) component that aims to control certain attributes (e.g., politeness, emotion, humor, and any other suitable attribute or combination thereof) in text generated (e.g., by a natural language processing model) while preserving the content. In some implementations, the player engagement system utilizes TST, at least in part, due to a long history of use of TST in the field of natural language processing and a recent re-popularization due to the rise of deep neural models. In some embodiments, the player engagement system receives an input prompt from the game tracking system and weights the style transfer by a context engine based on preferences stored in a profile of the player, the weights corresponding to likeability, expertise and customer orientation and balanced with the core personality attributes stored in the profile of the player in order to personalize the gameplay based on both the player data and the current state of the game.

In some embodiments, the player engagement system comprises a context engine (e.g., a second component) that is specifically trained to understand the game being played. In some implementations, the player engagement system uses the context engine to track the patterns of a player's gameplay that are generated by the game tracking system and stored in the player's profile, and the player's reaction to each of those outcomes throughout each gaming session. In some embodiments, the context engine creates the rapport attribute weights for the TST based on the current state of the player's game. In some implementations, the TST uses these updated attribute weights to generate the prompt for the player, the prompt providing the functional knowledge for the player to make a gameplay decision in a manner that optimizes the dealer's rapport given the context of the current game, the stored player information, and the game session.

For example, in some embodiments, when a player is on a losing streak and their mood is souring, the game tracking system and the context engine detect both the change in the player's reactions and the losing streak and provide relevant data indicating the current state to the player engagement system so that future responses created by the TST can be weighted to reflect the current situation, simultaneously accounting for the historical data stored in the player profile indicating how the player reacts to losing, and adjust the dealer prompts to suit which historical responses worked best.

In some embodiments, the player engagement system generates an output available to the dealer that indicates the current state of gameplay and displays prompts for the dealer to help engage with the players. For example, in some implementations, the player engagement system generates for display facilitator interface 108 at facilitator device 104 to provide tracked event information (e.g., gameplay information) and suggested phrases to be said to specific players determined based on the tracked event information and the historical data stored in a user profile of each specific player.

In some embodiments, while these skills might come naturally to highly experienced dealers, the player engagement system provides prompts to all live dealers in order to create a higher-quality, more consistent experience for players regardless of skill of the human dealer. In some implementations, the player engagement system is shared by all dealers, allowing the online casino application (e.g., shared experience application) to deliver a consistent personalized experience for each player.

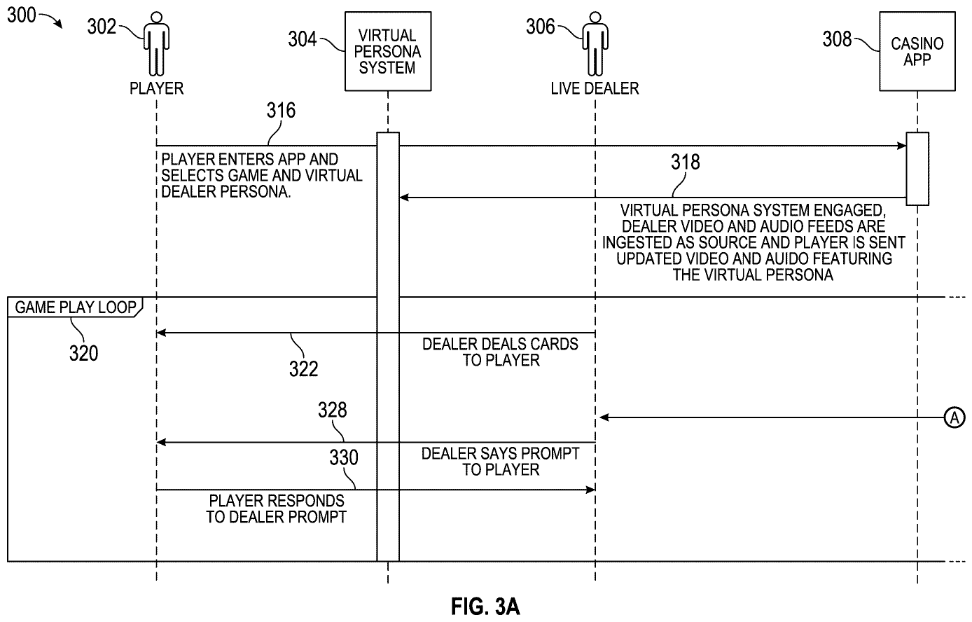

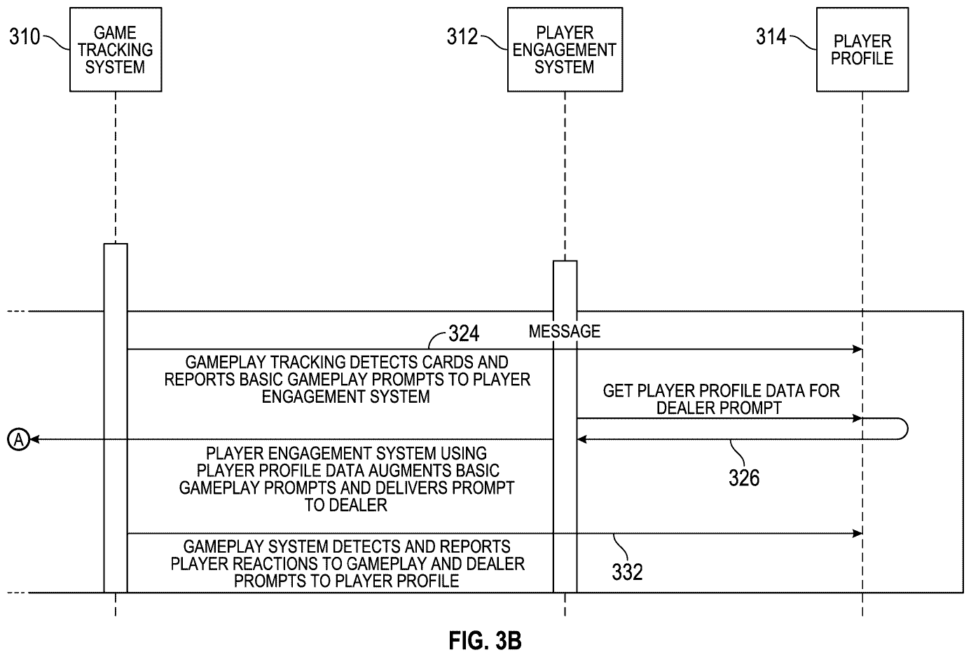

FIGS. 3A and 3B comprise a sequence diagram that depicts process 300 comprising player 302, virtual persona system 304, live dealer 306, casino app 308, game tracking system 310, player engagement system 312, and player profile 314. Process 300 may be implemented at least in part by, for example, system 100 of FIG. 1. In some implementations, player 302 is a user of user device 102 of FIG. 1 or user device 206, user device 210, or user device 214 of FIG. 2. In some embodiments, live dealer 306 is a facilitator of facilitator device 104 of FIG. 1 or is facilitator 204 of FIG. 2. In some embodiments, casino app 308 is supported by shared experience application server 112 of FIG. 1. In some implementations, player profile 314 is stored in user database 114 of FIG. 1 (e.g., “discostu,” “pollito”). In some embodiments, virtual persona system 304 is implemented across a plurality of servers.

In some embodiments, at 316, player 302 launches casino app 308 on their device and selects a game and a corresponding virtual dealer persona. In some implementations, at 318, virtual persona system 304 engages (e.g., in response to player 302 selecting the game and virtual dealer persona) resulting in a dealer video and audio feed being ingested as source and an updated video and audio featuring the virtual persona (e.g., personalized for player 302) being sent to player 302. In some embodiments, in response to player 302 selecting the game and virtual dealer persona, game tracking system 310 begins tracking game play and providing feedback to player engagement system 312 on what is happening in the current game. In some implementations, in response to player 302 selecting the game and virtual dealer persona, player engagement system 312 begins providing conversation prompts to dealer based on the state of the game play and player profile data (e.g., as stored in player profile 314). In some embodiments, in response to player 302 selecting the game and virtual dealer persona, process 300 enters into game play loop 320.

In some embodiments, at 322, live dealer 306 deals a card (e.g., for player 302). In some implementations, at 324, gameplay tracking system 310 detects a dealt card and sends a basic gameplay prompt to player engagement system 312. For example, if an ace is played, gameplay tracking system may determine that the most likely move would be to hit and report a gameplay prompt to gameplay engagement system 312 stating “Great! An ace! Would you like to hit?” In some embodiments, gameplay tracking system 310 stores a record of the detected gameplay (e.g., the dealt card). In some embodiments, at 326, player engagement system 312 accesses player profile data relevant to the reported basic gameplay prompt from player profile 314, uses the accessed player profile data to augment the reported basic gameplay prompt, and delivers the personalized (e.g., augmented) prompt to live dealer 306 (e.g., at a device of live dealer 306). In some implementations, at 328, live dealer 306 utters the content of the delivered personalized prompt which is heard by player 302 (e.g., by outputting, at the device of player 302, the sound recorded and transmitted by the device of live dealer 306). In some embodiments, at 330, player 302 responds to the uttered personalized prompt (e.g., by saying something back, by sending a reaction through an interface for engaging with casino app 308, by making a facial expression, or any other suitable reaction or combination thereof). In some implementations, at 332, game tracking system 332 detects the reaction of player 302 (e.g., by a facial recognition, by a language processing model, or any other suitable detection method of combination thereof) to the uttered personalized prompt and/or the gameplay, and reports the detected reaction to player profile 314 (e.g., to build an emotional model and communication model of player 302). In some implementations, process 300 remains in gameplay loop 320 until the game ends.

In some embodiments, the system (e.g., system 100 of FIG. 1) dynamically creates and provides a virtual persona for each player at an online casino's gaming table (e.g., by virtual persona system 304). In some implementations, the system uses AI-based, real-time video processing and deep learning models to dynamically create and provide a personalized virtual persona for each player. In some embodiments, the system relies on existing AI-based, real-time video processing and deep learning models such as NVIDIA Maxine™ which is a collection of high-performance, easy-to-use, NVIDIA NIM™ microservices and SDKs for deploying AI features that enhance audio, video, and augmented reality (AR) effects (e.g., enables the generation of personalized virtual personas). In some implementations, the system accesses audio and video augmentation capabilities via microservices designed for secure, reliable, high-performance deployment across clouds, data centers, and workstations. In some embodiments, the system comprises accelerated and optimized AI features for real-time inference on GPUS, resulting in low-latency audio, video, and AR effects with high network resilience (e.g., such as NVIDIA Maxine™). In some implementations, the system comprises audio and video enhancement/modification pipelines of multiple low-latency effects chained together. In some embodiments, the system uses cloud-native microservices to allow for flexible, fast deployment and updates. In some implementations, the system uses AI-driven eye contact correction, creates lifelike facial animations from a single portrait photo that is synchronized with audio input, and/or uses any other suitable AI-driven solutions for providing a virtual persona to each participant engaged with an online shared experience.

In some implementations, the system receives, e.g., from a respective device of each player engaging with the online casino application, a selection of a preferred virtual dealer persona at the time each respective player joins the table. In some embodiments, the system causes the single live human dealer to be represented to each player (e.g., at their respective user device) with a unique video feed featuring the virtual persona being animated based on the actions of the live dealer. In some implementations, the system performs server-based rendering by applying AI transformations on a server and then transmits a stream of each customized feed to each participant. In some embodiments, the system generates (e.g., by virtual persona system 304) a customized feed (e.g., rendering of a virtual persona based on a live facilitator) based on a context (e.g., preferences of a user). In some implementations, the system runs multiple instances of transformations (e.g., corresponding to a number of participants engaged with the shared experience that are indicated as opting in to personalized feeds) to a received feed (e.g., from a device of a live facilitator). In some embodiments, the system associates each instance of transformation with a specific user and the specific user is indicated (e.g., within the application environment on the user device) as being subscribed to such transformations. In some implementations, the system creates and delivers multiple personalized virtual personas in real time, each virtual persona driven by the same human actor, which, for example, is the live dealer of the game. In some implementations, the system utilizes low-latency streaming protocols (e.g., Web Real-Time Communication) and GPU acceleration for session IDS (e.g., that are associated with specific users engaged with the shared experience application) that are indicated as having opted in to receiving a customized stream. In some embodiments, the system determines that the user profile of more than one user engaged with a shared experience indicates that the more than one user has similar preferences, patterns, habits, or any other suitable attribute indicated by the data stored in association with the user profiles. In some implementations, when the system determines that a similarity score between two user profiles is over a threshold value, the system creates and delivers the same personalized virtual persona to a respective user device of the two user profiles having the similarity score over the threshold value.

In some embodiments, the system determines the most desirable dealer persona (e.g., corresponding to a live, default dealer) for a particular player, optionally based in part on a determined current state of the player. In some implementations, while physical attraction is considered by the system as one of the pillars of building rapport (e.g., between a user and a facilitator), system 100 accounts for specific representations of what an “ideal” facilitator would be for each user (e.g., based on selections received from a device of each user, based on tracked user reactions, based on any suitable stored data indicating user preferences). In some embodiments, the system generates the facilitator as a Wild West cowboy for a subset of users. In some implementations, the system generates the facilitator as a more veteran dealer persona and accordingly modifies the player engagement model weights to indicate, e.g., greater expertise or cranky banter by the facilitator in the responses to that player. In some embodiments, the system associates these additional attributes with a specific virtual persona and updates these attributes and/or model weights based on feedback data collected from the player interactions with the virtual persona.

In some implementations, the system is continuously fine-tuning and updating virtual personas associated with a user profile based on the detected behavior of the user. In some embodiments, based on feedback from the game tracking system on the player interactions during gameplay, the system causes the virtual persona to exhibit more specific personality traits assigned to the virtual persona, so the virtual persona could become more sassy, cranky, or demure based on the player interactions, and scores the specific personality traits in real time based on the gameplay feedback (e.g., to indicate a level for each specific personality trait that the virtual persona should have). In some implementations, the system stores the personality attributes in the player profile for each virtual persona so that there is continuity for the player across gaming sessions and the virtual persona can be further refined to meet the preferences of the player from the entirety of the gameplay sessions the player has engaged in. While various examples are directed towards the disclosed systems and methods being utilized by an online casino application, the disclosed systems and methods may be used by any shared experience application, such as an online education application or an online auction application.

In some embodiments, the system presents a wide assortment of potential virtual personas to a user (e.g., via the user interface of a device of the user), the wide assortment of potential virtual personas being initially based on the available demographic information of the player, such as age, gender identify, ethnicity, country of residence and any other information that has been shared or collected by the shared experience application. In some implementations, as the player selects different virtual dealer personas, the system feeds these selections, as well as tracked interactions during gameplay, to the player engagement model to further refine the selection of virtual personas the player is presented with for their next gaming session.

In some embodiments, when a user has joined a shared experience as a participant, the system causes the virtual persona of the facilitator associated with the user to be active for all the interactions that the player witnesses (e.g., even when the facilitator is interacting with a different participant, the system continues to cause the virtual persona associated with the user to be generated for display at a device of the user). In some implementations, if a user is merely observing a shared experience (e.g., a poker game) and not actively participating, the system causes the user to see and hear (e.g., by causing an audio and video feed to be output at a device of the observing user) a personalized virtual persona interacting with each participant engaged in the shared experience. In some implementations, if a user is merely observing a shared experience and not actively participating, the system causes an audio and video feed to be output at a device of the observing user corresponding to the respective virtual persona associated with a participant that is currently engaged with the facilitator (e.g., the displayed virtual persona at the device of the observer continuously changes).

In some embodiments, to match the personalized visual representation of the virtual persona, the system adjusts the voice of the virtual persona so that the voice suits the visual representation, such as by causing a different accent or a softer or more laid-back voice to match the virtual persona based on a combination derived from both the visual representation of the virtual persona and the known preferences of the user. In some embodiments, the system initially determines a voice that suits the appearance of the virtual persona and, based on feedback and interactions received from the device of the user, modifies the appearance of the virtual persona and/or the determined voice, causing the voice and the visual of the virtual persona to diverge. In some implementations, the system provides language translation so that a single facilitator can provide support in multiple languages, thereby allowing players to hear all of the dealer's and other players conversations translated into that player's specified language of choice.

In some embodiments, the system de-ages or ages the voice to account for the difference between the live dealer and the virtual persona by using techniques such as the pitch synchronous overlap and add method (PSOLA), resulting in changes that are perceptible and realistic. In some implementations, the system utilizes generative adversarial networks (GANs) for style transfer, similar to those used in image processing for aging faces. In some embodiments, the system uses a voice aging neural network (VANN) to transform voice samples by converting them into spectrogram images and applying style transfer to make the voice sound younger or older, simultaneously ensuring that the identity of the speaker is maintained while altering the perceived age of the voice.

In some embodiments, the system identifies when a facilitator is giving comments that are directed to all participants and when the facilitator is providing instructions or comments directed to a single player. In some implementations, the system causes each participant to receive all of the of comments made by the dealer and other participants, personalized to whomever is speaking's virtual persona if the player has created one for the dealer or the other players at the table have created one for themselves, and additionally translated to the desired language of the listening player. In some embodiments, when each participant is utilizing a different virtual persona for the dealer, the system identifies any incongruities that occur in the conversations between other players (e.g., instances where the dealer's virtual persona the player has selected does not match the occurring conversation). In some implementations, the system accounts for these incongruities by muting or lowering the volume on other dealer/player interactions that do not involve the player; neutralizing the dealer/player interactions so that the intent and game-related information of the message re kept and delivered in a neutral tone, but all other intonation, content, and virtual persona-related conversation are removed; keeping the content as is, using the player's dealer's virtual persona for all of the other player's interactions as well, and leaving the other player's responses as is; altering all audio content to match the virtual persona the player has selected for the dealer and altering any conversations from the other players at the table to match; or any other suitable method or combination thereof.

In some embodiments, the system provides the disclosed methods to users that are engaged via a VR or XR headset environment (e.g., while other users are engaged via computers, or other 2D displays). In some implementations, the system delivers 3D or spatial video directly to the headset and/or causes a VR environment (e.g., a casino) to be created and generated around the live facilitator to build a more immersive environment for the VR/XR-wearing players. In some embodiments, the system accomplishes the delivery of the 3D or spatial video by either (a) shooting (e.g., with recording setup 202 of FIG. 2) the facilitator in front of a green screen and then all participants are delivered either 2D or 3D generated backgrounds to match their display type or (b) by using semantic segmentation to remove the facilitator from their background and provide a personalized VR environment for each VR player, allowing for more customization/personalization, such as generating an authentic Wild West saloon environment to match the crusty cowboy virtual persona that the player has selected for the dealer. In some implementations, because the facilitator is represented as a virtual persona, the system causes the entire scene to be rendered on the VR device, with the virtual persona system providing positional data on the facilitator's body and facial movements (e.g., and the cards as dealt) so that the participant's headset can render in real time a virtual replica of the video feed that is being sent to the non-VR participants engaged with the shared experience. In some embodiments, for the VR environment, the system requires each player engaged with the shared experience to have a virtual representative similar to a photorealistic version of an Xbox avatar or a Wii Mii in order to complete the scene/environment and match the facilitator's virtual persona. In some implementations, the system uses either a generic or a customized virtual persona for each player based on their preferences. In some embodiments, the system uses a motion processing system that converts 2D video into 3D motion animations and then uses the 3D motion animations to animate avatars or digital humans. In some implementations, the system determines 3D motion data based on the video (e.g., received from the live facilitator) and uses the 3D motion data to animate a 3D avatar (e.g., a personalized facilitator persona for a user) within an XR environment. In some embodiments, the system uses existing motion processing systems, such as DeepMotion™, to track the live facilitator (e.g., via face tracking, hand tracking, full-body markerless tracking) within the received video feed, extract 3D motion data based on the tracking, and generate a 3D persona of the live facilitator (e.g., in accordance with determined parameters based on a specific user the persona is generated for) based on the 3D motion data.

In some embodiments, the system locally renders a virtual facilitator (e.g., or any aspect of the shared experience as disclosed herein) when the system identifies that the user device engaged with the shared experience is in a low bandwidth situation, streaming the video is not viable, and/or bandwidth drops below an acceptable threshold during engagement with the shared experience, thereby allowing the user in the low bandwidth situation to continue engaging seamlessly. In some implementations, the system receives (a) an indication from the local device that the local device has determined that the device is in a low bandwidth scenario and (b) a request for the data feed to change to the shared experience application's server (e.g., shared experience application server 112 of FIG. 1). In some embodiments, the system causes the shared experience stream to consist of different layers depending on the available bandwidth, with the core delivery stream being event updates and text of the audio conversations between the facilitator and participants to provide the minimum level of data to engage in the shared experience. In some implementations, the system adds additional elements to the core stream such as the separated audio stream and skeletal and facial feature data from the facilitator to animate a locally rendered virtual facilitator.

In some embodiments, when two or more users engaged with the shared experience have selected highly similar virtual personas for their dealer (e.g., the selected virtual personas have a similarity score over a threshold value), the system determines that the two selected virtual personas are worth blending into a single virtual persona to optimize resource usage by the server. In some implementations, the virtual persona system blends the selected virtual personas into a single new virtual persona and utilizes the same processing system for all players now being served this single new virtual persona.

In some embodiments, the system uses haptic feedback to provide additional connection to the shared experience when a participant has a wearable device such as an Apple watch or XR headset and/or controllers. In some implementations, the system uses the haptic feedback to provide functionality to the users to high-five the facilitator or other participants and/or to detect that the user is tapping on the table, which in blackjack is indicative of wanting another card, providing a more realistic experience of being in a physical casino.

In some embodiments, the system provides customization and an improved user interface that extends beyond the personalization provided in the live shared experience session. For example, in some implementations, when a gamer reviews a recorded session, the system determines that interactions between the dealer and the other players playing at the same table might not be as notable or relevant anymore if the gamer just wants to see what happened between himself and the dealer. Further, in some embodiments, the system automatically tailors and optimizes the streaming of recorded video and playback of the content in this on-demand mode. For instance, in some implementations, the system generates a personalized playback stream that excludes the segments and/or portions of the original stream that correspond to other participants engaged in the earlier live shared experience session. In some embodiments, the system updates and/or adjusts the choices and/or preferences of a user based on the review of a recorded session.

In some embodiments, the system allows a gamer to review how the dealer of a previous live session interacted with the other players if (e.g., when the gamer did not pay attention to or comprehend those interactions during the live session). In some implementations, the system allows the gamers to make and/or adjust personal choices and preferences for use in future gaming session. For instance, in some embodiments, when the gamer is watching a stream of a previous live game the gamer participated in, the system receives an indication that the gamer finds the dealer's interaction with another player more intriguing and would like to experience the interaction in their own gaming experience. In some implementations, to provide such customized reviews, the system optimizes the recording of a live session via efficient content analysis, flexible encoding settings, and bitstream management. In some embodiments, the system provides the authorization for the reviews of recordings. For instance, in some implementation, the system only permits the players at the table of a live game to have access to the recordings and/or to grant limited access to a friend who did not play at the table but would like to see what happened between the gamer (e.g., not the other players playing at the table) and the dealer.

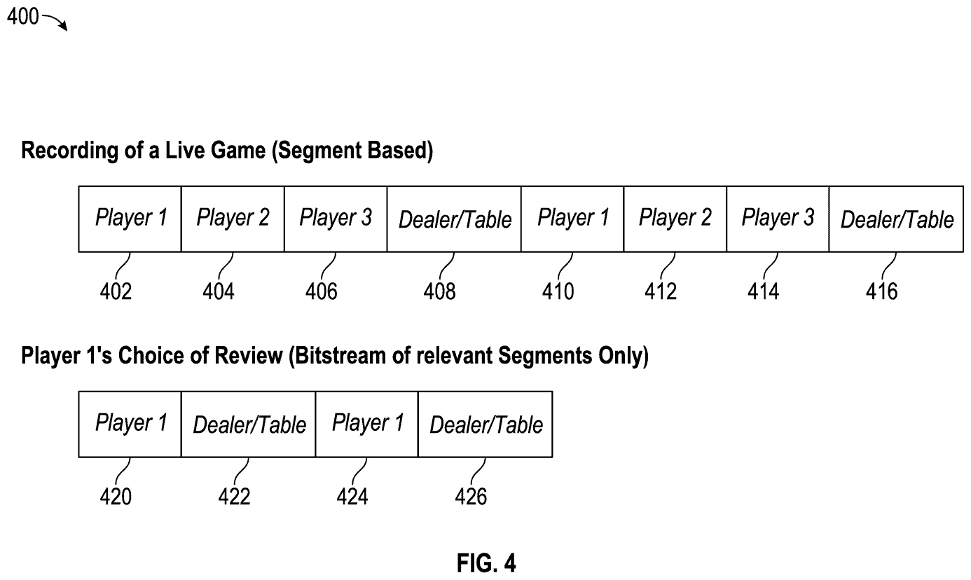

FIG. 4 depicts an illustrative system 400 for labeling and providing recordings of a virtual group event, in accordance with some embodiments of this disclosure. In some embodiments, system 400 comprises original segment 402, original segment 404, original segment 406, original segment 408, original segment 410, original segment 412, original segment 414, original segment 416, relevant segment 420, relevant segment 422, relevant segment 424, and relevant segment 426. In some embodiments, system 400 is system 100 of FIG. 1 or system 200 of FIG. 2. In some implementations, system 400 records original segments 402-416 during a live shared experience (e.g., a live game) and stores the original segments (e.g., in a recorded experience database) with metadata (e.g., what occurs in each segment, what entities are depicted in each segment, or any other suitable metadata or combination thereof). In some embodiments, system 400 determines metadata to be stored with each original segment based on analysis of the segment (e.g., visual analysis, audio analysis). For example, in some embodiments, system 400 determines that original segment 402 depicts an interaction involving Player 1 and subsequently stores original segment 402 with the metadata “Player 1,” an indication that original segment 402 is only relevant to Player 1, and/or an indication that only Player 1 may access and/or share access of original segment 402. Further, for example, in some implementations, system 400 determines that original segment 408 depicts an interaction between the dealer (e.g., facilitator of the shared experience) and the entire table (e.g., all participants engaged with the shared experience) and subsequently stores original segment 408 with the metadata “Whole table” and an indication that original segment 408 is relevant to all players engaged with the game.

In some implementations, system 400 presents the recorded original segments at a user device with an indication of the metadata that is stored with each segment. For example, in some embodiments, system 400 generates for display a plurality of selectable options corresponding to specific segments of a recorded live session (e.g., original segments 402-416) and indicates, for each segment, relevant information (e.g., the metadata each segment is stored with, the entities depicted in each segment, the look of the virtual facilitator persona depicted in each segment, the duration of each segment, and/or an event that occurred in each segment such as an auction item selling or a player busting in a game of blackjack). In some embodiments, system 400 allows a user to filter the segments based on the stored metadata to identify segments of interest (e.g., filtering by what user is active in the segment). In some implementations, system 400 allows a user to select segments of interest for review. In some embodiments, system 400 prompts a user to request permission to stream a recorded segment involving another user and/or allows users to grant permission to other users to access recorded segments involving them.

In some embodiments, system 400 identifies relevant segments and generates a relevant collection of segments for viewing by a user. For example, in some implementations, systems 400 identifies relevant segment 420 (e.g., corresponding to original segment 402), relevant segment 422 (e.g., corresponding to original segment 408), relevant segment 424 (e.g., corresponding to original segment 410), and relevant segment 426 (e.g., corresponding to original segment 416) as relevant to Player 1 (e.g., because each segment depicts a scene that involved the user). In some embodiments, system 400 only allows a user to stream segments of past live sessions that the user has permission to view (e.g., the user was involved in the scenes). In some implementations, system 400 allows a user to share their personal recorded live session segments with other users (e.g., family or friends of the user).

FIG. 5 shows generalized embodiments of illustrative user equipment devices 500 and 501. For example, user equipment device 500 may be a smartphone device (e.g., user device 102 of FIG. 1). In another example, user equipment device 501 may be a user television equipment system. User television equipment system 501 may include set-top box 516. Set-top box 516 may be communicatively connected to microphone 518, speaker 514, and display 512. In some embodiments, microphone 518 may receive voice commands for a media or communication application. In some embodiments, display 512 may be a television display or a computer display. In some embodiments, set-top box 516 may be communicatively connected to user input interface 510. In some embodiments, user input interface 510 may be a remote control device or a touchscreen. Set-top box 516 may include one or more circuit boards. In some embodiments, the circuit boards may include processing circuitry, control circuitry, and storage (e.g., RAM, ROM, hard disk, removable disk, etc.). In some embodiments, the circuit boards may include an input/output path. More specific implementations of user equipment devices are discussed below in connection with FIG. 6. Each one of user equipment device 500 and user equipment device 501 may receive content and data via input/output (I/O) path 502. In some embodiments, I/O path 502 is I/O circuitry. I/O path 502 may provide content (e.g., messages, calls, broadcast programming, on-demand programming, Internet content, content available over a local area network (LAN) or wide area network (WAN), and/or other content) and data to control circuitry 504, which includes processing circuitry 506 and storage 508. Storage 508 comprises the instructions for providing a personalized experience for individual users engaged in a virtual group event as described in FIGS. 1-4, when executed by processing circuitry 506. Control circuitry 504 may be used to send and receive commands, requests, and other suitable data using I/O path 502, which may comprise I/O circuitry. I/O path 502 may connect control circuitry 504 (and specifically processing circuitry 506) to one or more communications paths (described below). I/O functions may be provided by one or more of these communications paths but are shown as a single path in FIG. 5 to avoid overcomplicating the drawing.

Control circuitry 504 may be based on any suitable processing circuitry such as processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions stored in memory (e.g., storage 508) for providing a personalized experience for individual users engaged in a virtual group event as described in FIGS. 1-4. Specifically, control circuitry 504 may perform the functions discussed above and below. In some implementations, any action performed by control circuitry 504 may be based on instructions received from the shared experience application (e.g., system 100 of FIG. 1, system 200 of FIG. 2).

In client/server-based embodiments, control circuitry 504 may include communications circuitry suitable for communicating with a communications application server or other networks or servers. The instructions for carrying out the above-mentioned functionality may be stored on a server (which is described in more detail in connection with FIG. 6). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 6). In addition, communications circuitry may include circuitry that provides peer-to-peer communication of user equipment devices, communication between a user and a contact of the user, or communication of user equipment devices in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 508 may be used to store various types of content described herein as well as the user database (e.g., user database 114 of FIG. 1) or the recorded experience database as described above. Nonvolatile memory may also be used (e.g., to launch a boot-up routine and other instructions). Cloud-based storage, described in relation to FIG. 6, may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 504 may also include scaler circuitry for upconverting and downconverting content into the preferred output format of user equipment 500. Circuitry 504 may also include digital-to-analog converter circuitry and analog-to-digital converter circuitry for converting between digital and analog signals. The tuning and encoding circuitry may be used by user equipment device 500, 501 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 508 is provided as a separate device from user equipment device 500, the tuning and encoding circuitry (including multiple tuners) may be associated with storage 508.

A user may send instructions to control circuitry 504 using user input interface 510 (e.g., user interface 106a or 106b of FIG. 1). User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of user equipment device 500 and user equipment device 501. For example, display 512 may be a touchscreen or touch-sensitive display. In such circumstances, user input interface 510 may be integrated with or combined with display 512. Display 512 may be one or more of a monitor, a television, a display for a mobile device, or any other type of display. A video card or graphics card may generate the output to display 512. The video card may be any processing circuitry described above in relation to control circuitry 504. The video card may be integrated with the control circuitry 504. Speakers 514 may be provided as integrated with other elements of each one of user equipment device 500 and user equipment device 501 or may be stand-alone units. The audio component of videos and other content displayed on display 512 may be played through the speakers 514. In some embodiments, the audio may be distributed to a receiver (not shown), which processes and outputs the audio via speakers 514.

The system for providing a personalized experience for individual users engaged in a virtual group event as described in FIGS. 1-4 may be implemented using any suitable architecture. For example, the system may be a stand-alone system wholly implemented on each one of user equipment device 500 and user equipment device 501. In such an approach, instructions of the system are stored locally (e.g., in storage 508), and data for use by the system is downloaded on a periodic basis (e.g., from an out-of-band feed, from an Internet resource, or using another suitable approach). Control circuitry 504 may retrieve instructions for the system from storage 508 and process the instructions to perform the providing the personalized experience for individual users engaged in a virtual group event. Based on the processed instructions, control circuitry 504 may determine what action to perform when input is received from user input interface 510. For example, movement of a cursor on a display up/down may be indicated by the processed instructions when user input interface 510 indicates that an up/down button was selected.

In some embodiments, the system for providing a personalized experience for individual users engaged in a virtual group event is a client/server-based application. Data for use by a thick or thin client implemented on each one of user equipment device 500 and user equipment device 501 is retrieved on-demand by issuing requests to a server remote to each one of user equipment device 500 and user equipment device 501. In one example of a client/server-based guidance application, control circuitry 504 runs a web browser that interprets web pages provided by a remote server. For example, the remote server may store the instructions for the shared experience application in a storage device. The remote server may process the stored instructions using circuitry (e.g., control circuitry 504) to perform the operations discussed in connection with FIGS. 1-4 and 7.

In some embodiments, the system for providing a personalized experience for individual users engaged in a virtual group event may be downloaded and interpreted or otherwise run by an interpreter or virtual machine (run by control circuitry 504). In some embodiments, the system for providing a personalized experience for individual users engaged in a virtual group event may be encoded in the ETV Binary Interchange Format (EBIF), received by the control circuitry 504 as part of a suitable feed, and interpreted by a user agent running on control circuitry 504. For example, the system for providing a personalized experience for individual users engaged in a virtual group event may be an EBIF application. In some embodiments, the system for providing a personalized experience for individual users engaged in a virtual group event may be defined by a series of JAVA-based files that are received and run by a local virtual machine or other suitable middleware executed by control circuitry 504. In some of such embodiments (e.g., those employing MPEG-2 or other digital media encoding schemes), the system for providing a personalized experience for individual users engaged in a virtual group event may be, for example, encoded and transmitted in an MPEG-2 object carousel with the MPEG audio and video packets of a program.

FIG. 6 shows illustrative devices and systems for providing a personalized experience for individual users engaged in a virtual group event, in accordance with some embodiments of this disclosure. User equipment devices 607, 608, 610 (e.g., user device 101) may be coupled to communication network 606. Communication network 606 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 606) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 6 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 606.

System 600 includes a media content source 602 and a server 604, which may comprise or be associated with database 605. Communications with media content source 602 and server 604 may be exchanged over one or more communications paths but are shown as a single path in FIG. 6 to avoid overcomplicating the drawing. In addition, there may be more than one of each of media content source 602 and server 604, but only one of each is shown in FIG. 6 to avoid overcomplicating the drawing. If desired, media content source 602 and server 604 may be integrated as one source device.

In some embodiments, server 604 may include control circuitry 611 and a storage 614 (e.g., RAM, ROM, Hard Disk, Removable Disk, etc.). Server 604 may also include an input/output path 612. I/O path 612 may provide device information, or other data, over a local area network (LAN) or wide area network (WAN), and/or other content and data to the control circuitry 611, which includes processing circuitry, and storage 614. The control circuitry 611 may be used to send and receive commands, requests, and other suitable data using I/O path 612, which may comprise I/O circuitry. I/O path 612 may connect control circuitry 604 (and specifically processing circuitry) to one or more communications paths.

Control circuitry 611 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 611 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 611 executes instructions for an emulation system application stored in memory (e.g., the storage 614). Memory may be an electronic storage device provided as storage 614 that is part of control circuitry 611.

Server 604 may retrieve guidance data from media content source 602, process the data as will be described in detail below, and forward the data to user equipment devices 607, 608 and 610. Media content source 602 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 602 may be the originator of content (e.g., a television broadcaster, a Webcast provider, etc.) or may not be the originator of content (e.g., an on-demand content provider, an Internet provider of content of broadcast programs for downloading, etc.). Media content source 602 may include cable sources, satellite providers, on-demand providers, Internet providers, over-the-top content providers, or other providers of content. Media content source 602 may also include a remote media server used to store different types of content (including video content selected by a user), in a location remote from any of the client devices. Media content source 602 may also provide metadata that can be used to identify segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 604), which may be located centrally or at distributed locations, that provide cloud-based services to various types of users and devices connected via a network such as the Internet via communication network 606. In such embodiments, user equipment devices may operate in a peer-to-peer manner without communicating with a central server.

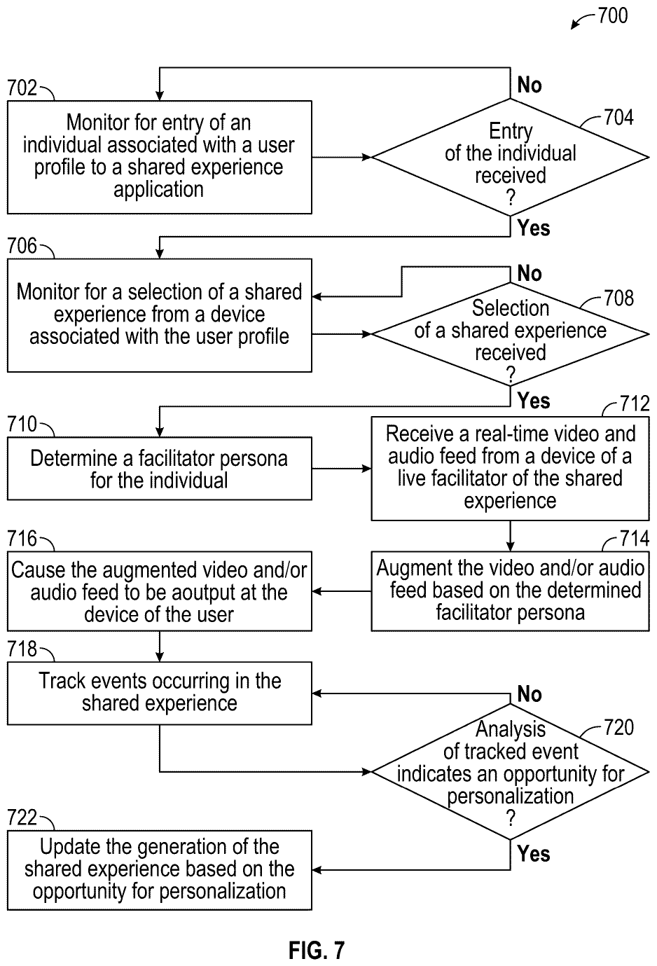

FIG. 7 is flowchart of detailed illustrative process 700 for providing a personalized experience for individual users engaged in a virtual group event (e.g., via user device 102 of FIG. 1 or user device 206 of FIG. 2), in accordance with some embodiments of this disclosure. Process 700 may be implemented at least in part by, for example, control circuitry 504 of FIG. 5, I/O path 502 (e.g., circuitry) of FIG. 5, and/or control circuitry 611 of FIG. 6. In various embodiments, the individual steps of process 700 may be implemented by one or more components of the devices and applications of FIGS. 1-6. Although the present disclosure may describe certain steps of process 700 (and of other processes described herein) as being implemented by certain components of the devices and applications of FIGS. 1-6, this is for purposes of illustration only. Other components of the devices and systems of FIGS. 1-6 may implement those steps instead. In addition, one or more steps of process 700 may be incorporated into or combined with one or more steps of any other process or embodiment.

In some embodiments, process 700 begins at 702, where the control circuitry (e.g., control circuitry 504 of FIG. 5 and/or control circuitry 611 of FIG. 6), monitors for entry of an individual associated with a user profile to a shared experience application (e.g., an individual launches the shared experience application on their device). In some implementations, process 700 proceeds to 704, where the control circuitry determines if entry of the individual associated with the user profile has been received. In some embodiments, when the control circuitry determines that entry of the individual has not been received (e.g., 702=No), process 700 returns to 702. In some implementations, when the control circuitry determines that entry of the individual has been received (e.g., 702=Yes), process 700 proceeds to 706 where the control circuitry monitors for a selection of a shared experience from a device associated with the user profile (e.g., user selects a shared experience to engage in). In some embodiments, process 700 proceeds to 708, where the control circuitry determines if a selection of a shared experience has been received from the device associated with the user profile. In some implementations, when the control circuitry determines that a selection of a shared experience has not been received (e.g., 708=No), process 700 returns to 706. In some embodiments, when the control circuitry determines that a selection of a shared experience has been received (e.g., 708=Yes), process 700 proceeds to 710, where the control circuitry determines a facilitator persona for the individual (e.g., based on historical data, based on a selection received from the device of a user).

In some embodiments, at 712, the control circuitry receives a real time video and audio feed from a device of a live facilitator of the selected shared experience (e.g., real-time video and audio feed from a dealer of a blackjack game that the user has joined). In some implementations, at 714, the control circuitry augments the video and/or audio feed received from the device of the live facilitator based on the determined facilitator persona (e.g., modifies the depiction of the facilitator to match the facilitator persona for the individual, modifies the audio to align with the depiction of and/or the traits of the facilitator persona). In some embodiments, at 716, the control circuitry causes the augmented video and/or audio feed to be output at the device of the user. In some implementations, at 718, the control circuitry tracks events occurring in the shared experience (e.g., tracks the moves made and cards dealt in a poker game, tracks conversations, tracks reactions). In some embodiments, at 720, the control circuitry determines if an analysis of the tracked events indicates an opportunity for personalization for the user. In some implementations, when the control circuitry determines that the analysis of the tracked events does not indicate an opportunity for personalization (e.g., 708=No), process 700 returns to 718. In some embodiments, when the control circuitry determines that the analysis of the tracked events indicates an opportunity for personalization (e.g., 708=Yes), process 700 proceeds to 722, where the control circuitry updates the generation of the shared experience based on the opportunity for personalization (e.g., updates a depiction of the facilitator persona, updates a weighted trait of the facilitator persona, updates a generated prompt for the live facilitator).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving an indication of entry of an individual entity associated with an individual profile to a shared experience application;
identifying a selected facilitator persona based at least in part on inputs received from the individual entity associated with the individual profile;
receiving an indication of acceptance of the individual entity by the shared experience application;
receiving a real-time video and/or audio feed from the shared experience application;
tracking an interactive event occurring between the individual entity and a real-time facilitator entity based at least in part on the real-time video and/or audio feed; and
generating information for output in accordance with the selected facilitator persona based at least in part on the tracked interactive event.

2. The method of claim 1, wherein:
the individual entity associated with the individual profile corresponds to a real-time player entity associated with a player profile of an online card-based/casino gaming application,
the selected facilitator persona corresponds to a virtual dealer persona,
the real-time video and/or audio feed corresponds to a specific game hosted by the real-time facilitator entity on the card-based/casino gaming application,
the interactive event corresponds to an interactive gameplay event, and
the real-time facilitator entity corresponds to a real-time dealer entity.

3. The method of claim 1, wherein:
the individual entity associated with the individual profile corresponds to a real-time student entity associated with a student profile of an online education application,
the selected facilitator persona corresponds to a virtual teacher persona,
the interactive event corresponds to an interactive educational event, and
the real-time facilitator entity corresponds to a real-time teacher entity.

4. The method of claim 1, wherein:
the individual entity associated with the individual profile corresponds to a real-time bidder entity associated with a bidder profile of an online auction application,
the selected facilitator persona corresponds to a virtual auctioneer persona,
the interactive event corresponds to an interactive auction event, and
the real-time facilitator entity corresponds to a real-time auctioneer entity.

5. The method of claim 1, wherein the information for output comprises an updated real-time video and/or audio feed comprising the selected facilitator persona.

6. The method of claim 1, wherein the information for output is based at least in part on at least one of real-time feedback, a social cue, an event history, a reaction to an event outcome, or the individual profile.

7. The method of claim 2, wherein the tracking comprises detecting a real-time played card as an object based at least in part on an analysis of the real-time video and/or audio feed.

8. The method of claim 7, wherein the tracking comprises determining the interactive gameplay event based at least in part on detecting the real-time played card.

9. The method of claim 2, comprising transmitting information indicating a basic gameplay prompt to a player engagement system based at least in part on the interactive gameplay event, wherein the player engagement system is caused to:
access individual profile data for generating a dealer prompt based at least in part on the individual profile;
generate, based at least in part on the accessed individual profile data, a personalized gameplay prompt; and
transmit for display to the real-time facilitator entity the personalized gameplay prompt.

10. The method of claim 9, comprising detecting and reporting a reaction of the individual entity to the interactive gameplay event.

11-44. (canceled)

45. A system comprising:
input/output (I/O) circuitry configured to:
receive an indication of entry of an individual entity associated with an individual profile to a shared experience application;
control circuity configured to:
identify a selected facilitator persona based at least in part on inputs received from the individual entity associated with the individual profile;
wherein the I/O circuitry is further configured to:
receive an indication of acceptance of the individual entity by the shared experience application;
receive a real-time video and/or audio feed from the shared experience application;
wherein the control circuity is further configured to:
track an interactive event occurring between the individual entity and a real-time facilitator entity based at least in part on the real-time video and/or audio feed; and
generate information for output in accordance with the selected facilitator persona based at least in part on the tracked interactive event.

46. The system of claim 45, wherein:
the individual entity associated with the individual profile corresponds to a real-time player entity associated with a player profile of an online card-based/casino gaming application,
the selected facilitator persona corresponds to a virtual dealer persona,
the real-time video and/or audio feed corresponds to a specific game hosted by the real-time facilitator entity on the card-based/casino gaming application,
the interactive event corresponds to an interactive gameplay event, and
the real-time facilitator entity corresponds to a real-time dealer entity.

47. The system of claim 45, wherein:
the individual entity associated with the individual profile corresponds to a real-time student entity associated with a student profile of an online education application,
the selected facilitator persona corresponds to a virtual teacher persona,
the interactive event corresponds to an interactive educational event, and
the real-time facilitator entity corresponds to a real-time teacher entity.

48. The system of claim 45, wherein:
the individual entity associated with the individual profile corresponds to a real-time bidder entity associated with a bidder profile of an online auction application,
the selected facilitator persona corresponds to a virtual auctioneer persona,
the interactive event corresponds to an interactive auction event, and
the real-time facilitator entity corresponds to a real-time auctioneer entity.

49. The system of claim 45, wherein the information for output comprises an updated real-time video and/or audio feed comprising the selected facilitator persona.

50. The system of claim 45, wherein the information for output is based at least in part on at least one of real-time feedback, a social cue, an event history, a reaction to an event outcome, or the individual profile.

51. The system of claim 46, wherein the control circuity is further configured to detect a real-time played card as an object based at least in part on an analysis of the real-time video and/or audio feed.

52. The system of claim 51, wherein the control circuity is further configured to determine the interactive gameplay event based at least in part on detecting the real-time played card.

53. The system of claim 46, wherein the I/O circuitry is further configured to transmit information indicating a basic gameplay prompt to a player engagement system based at least in part on the interactive gameplay event, wherein the player engagement system is caused to:
access individual profile data for generating a dealer prompt based at least in part on the individual profile;
generate, based at least in part on the accessed individual profile data, a personalized gameplay prompt; and
transmit for display to the real-time facilitator entity the personalized gameplay prompt.

54. The system of claim 53, wherein the control circuity is further configured to detect and report a reaction of the individual entity to the interactive gameplay event.

55-220. (canceled)
